(19) United States
(12) Patent Application Publication
(10) Pub. No.: US 2010/0063862 A1
(43) Pub. Date: Mar. 11, 2010

(54) MEDIA DELIVERY SYSTEM AND SYSTEM INCLUDING A MEDIA DELIVERY SYSTEM AND A BUILDING AUTOMATION SYSTEM

(76) Inventors: RONALD L. THOMPSON, Knoxville, TN (US); BRANDON J. ROGERS, Knoxville, TN (US)

Correspondence Address: Martin J. Moran;Eaton Electrical, Inc., 1000 Cherrington Parkway, Moon Township, PA, 15108, US

(21) Appl. No.: 12/206,379

(22) Filed: Sep. 8, 2008

(51) Int. Cl. G06Q 30/00; G06Q 10/00

(52) U.S. Cl. 705/10; 705/14.58

(57) ABSTRACT

A media delivery system includes a number of inputs structured to input information pertaining to a number of customers, information pertaining to a number of demographics of the number of customers, or information pertaining to a number of products possessed by the number of customers. A media server inputs the number of inputs and determines corresponding marketing information directly pertaining to at least one of the number of customers, the number of demographics or the number of products. A number of media outputs are output from the media server. The number of media outputs output the corresponding marketing information to a corresponding number of the number of customers.

### BACKGROUND OF THE INVENTION

1. Field of the Invention

This invention pertains generally to media delivery systems and, more particularly, to such systems employed for outputting marketing information. The invention also pertains to systems including a media delivery system and a building automation system.

2. Background Information

A conventional “green” solution involves building with the express purpose of creating a relatively more energy efficient facility in terms of environmental conservation and/or reduced energy costs. Known building automation systems (BASs) improve overall energy usage efficiency by automating processes that are often left unattended (e.g., without limitation, lighting control; HVAC control).

Wired BASs employ a significant amount of wiring for control, monitoring and communications. The granularity of control is very broad and the price per lighting node or HVAC node is relatively expensive. In contrast, wireless BASs (e.g., without limitation, using ZigBee™ Alliance) reduce installation costs, give substantially more granularity of control, and reduce the price per wireless node.

Interactive multimedia is often used today within retail, entertainment venues, educational facilities (e.g., without limitation, museums) and tradeshow environments to convey information to the customer.

In-store marketing campaigns and multimedia marketing are becoming more dynamic to attract the attention of customers. Known marketing campaigns and multimedia marketing in brick and mortar stores are not personalized to the person viewing the same.

After performing in-store marketing campaigns and multimedia marketing, point-of-sale (POS) records over the same time are obtained and subsequent analysis is performed to try and determine the correlation and effectiveness of the marketing method being used. Since this analysis is not done in real time, the effectiveness is often difficult to verify or quantify.

U.S. Patent Application Publication No. 2007/0205962 discloses a display system including a control device comprised of a server having a storage apparatus with a number of routines stored therein, and a processor structured to execute at least one of the routines to produce output information. The routines include a wireless communication routine and an audio/video routine. The wireless communication routine includes a ZigBee™ I/O plug-in. The audio/video routine includes a multimedia editing software platform in which a user may create an audio/video sequence and then synchronize the audio/video sequence with one or more output devices using the ZigBee™ I/O plug-in to create an automated experience. The user may create a video clip and soundtrack related to one or more products being displayed. The video clip and soundtrack can be integrated with the ZigBee™ I/O plug-in, in order that when any customer approaches a motion sensor, the video clip is output on a video display and the soundtrack is output on a speaker.

The wireless communication routine can include a ZigBee™ I/O routine and the audio/video routine can include a stream-file editor and a scripting interface. The stream-file editor creates and edits stream files (e.g., video; audio; device settings). The scripting interface creates script files using these stream files as focal points for later execution. The server oversees the implementation and execution of the script files relative to the wireless communication routine.

In Publication 2007/0205962, which is incorporated by reference herein, the customer may be guided through the display system by a series of programmed actions, or may interact with the display system with an array of actions occurring based on specific input received from the customer via strategically placed sensors. For example, if a motion sensor detects a customer standing for a period of time near the display system, a signal will be sent to the server by an I/O module. The server may then communicate output information (e.g., audio/video information; control information) to the other components of the display system. For example, the server may send control information to a switch causing overhead lighting to dim and may send audio/video information to a video display and speaker causing a prerecorded message to be played thereon. The overhead lighting, display specific lighting, and a scent generator may all be adjusted based on the control information communicated by the server.

The display system may be adapted to interface with preexisting input, output and control devices. A retail store, for instance, may employ a preexisting control system which includes a number of wireless switches for controlling the operation of overhead lighting. The server may be installed in the retail store and configured as a substitute for, or as a compliment to, the preexisting control system. Thus, the overhead lighting as well as other devices (e.g., HVAC system; automatic doors) originally controlled by the preexisting control system may be incorporated into the unique customer experience.

There is room for improvement in media delivery systems.

There is also room for improvement in systems including a media delivery system and a building automation system.

### SUMMARY OF THE INVENTION

These needs and others are met by embodiments of the invention.

In accordance with one aspect of the invention, a media delivery system comprises: a number of inputs structured to input information pertaining to a number of customers, information pertaining to a number of demographics of the number of customers, or information pertaining to a number of products possessed by the number of customers; a media server structured to input the number of inputs and to determine corresponding marketing information directly pertaining to at least one of the number of customers, the number of demographics or the number of products; and a number of media outputs from the media server, the number of media outputs being structured to output the corresponding marketing information to a corresponding number of the number of customers.

The number of inputs may be structured to input information pertaining to the number of products; and the number of media outputs may be structured to output a marketing message as the corresponding marketing information.

The number of inputs may be further structured to determine a number of specific types of the number of products.

The number of inputs may be structured to input from a smartcard to determine a specific person as the number of customers.

The number of inputs may include a number of RFID tags operatively associated with one of the number of customers.

As another aspect of the invention, a media delivery system comprises: a number of inputs structured to input information; a media server structured to input the number of inputs and to determine corresponding marketing information directed to a number of customers; and a number of media outputs from the media server, the number of media outputs being structured to output the corresponding marketing information to a corresponding number of the number of customers, wherein the media server is further structured to determine effectiveness of the corresponding marketing information.

The media server may be further structured to determine the effectiveness in real time.

The corresponding marketing information may be directed to a plurality of products on a shelf; and the media server may be further structured to determine the effectiveness from a metric selected from the group consisting of: (a) a count of persons proximate the number of media outputs divided by a count of outputs of the corresponding marketing information; (b) a count of sold or leased products related to the corresponding marketing information divided by a count of outputs of the corresponding marketing information; (c) a count of products related to the corresponding marketing information and being removed from the shelf divided by a count of outputs of the corresponding marketing information; and (d) a count of sales or lease revenue for products related to the corresponding marketing information divided by a count of outputs of the corresponding marketing information.

As another aspect of the invention, a system comprises: a building automation system comprising: a processor, a plurality of inputs to the processor, and a plurality of outputs from the processor; a media delivery system comprising: a server, a plurality of inputs to the server, and a plurality of media outputs from the server, a number of the media outputs from the server being a number of the outputs of the building automation system; and an interface between the building automation system and the media delivery system, the interface being structured to grant permission from the building automation system to the media delivery system to alter or control the number of the outputs of the building automation system.

The interface may be one of a token-passing mechanism and a handshaking mechanism between the building automation system and the media delivery system.

The building automation system may be structured to: (a) allow alteration or control of the number of the outputs of the building automation system by the media delivery system followed by normal operation of the number of the outputs by the building automation system; or (b) disallow alteration or control of the number of the outputs of the building automation system by the media delivery system and maintain normal operation of the number of the outputs by the building automation system.

The allow alteration or control of the number of the outputs of the building automation system by the media delivery system may provide a number of marketing functions; and the maintain normal operation of the number of the outputs by the building automation system may provide a number of energy management functions.

The number of the inputs to the server may be a number of the inputs to the processor.

### BRIEF DESCRIPTION OF THE DRAWINGS

A full understanding of the invention can be gained from the following description of the preferred embodiments when read in conjunction with the accompanying drawings in which:

FIGS. 1 and 2 are block diagrams of interactive media delivery systems in accordance with embodiments of the invention.

FIG. 3 is a block diagram of a system including an interactive media delivery system and a building automation system in accordance with other embodiments of the invention.

FIGS. 4-6 are block diagrams of interactive media delivery systems in accordance with other embodiments of the invention.

FIG. 7 is a flowchart of a procedure for requesting control of building automation system nodes by the interactive media delivery system of FIG. 3.

### DESCRIPTION OF THE PREFERRED EMBODIMENTS

As employed herein, the term “number” means one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “product” means a commodity, a good, a service, something that is produced for marketing, sale and/or lease, or something that is marketed, sold and/or leased.

As employed herein, the term “customer” means a person that purchases or leases a product; a potential purchaser or lessee of product; and/or a person that searches for, shops for, views and/or examines a marketed product.

As employed herein, the term “marketing” or variations thereof mean the act or process of selling, purchasing or leasing a product; the act or process of advertising, promoting, selling, leasing and/or distributing a product; and/or the act or process of calling something to the attention of a number of customers.

As employed herein, the term “demographics” means a number of characteristics (i.e., age; sex; height; weight; income; buying habits (or purchasing history); leasing habits (or leasing history); regional location (i.e., where a customer is from; where a customer lives); occupation or employment type; hobbies; and/or interests) of customers, which characteristics are useful for marketing a number of products and/or for identifying a number of markets.

As employed herein, the term “shelf” means a place where a product is placed before being sold to, leased to or possessed by a customer, or before being removed by a customer.

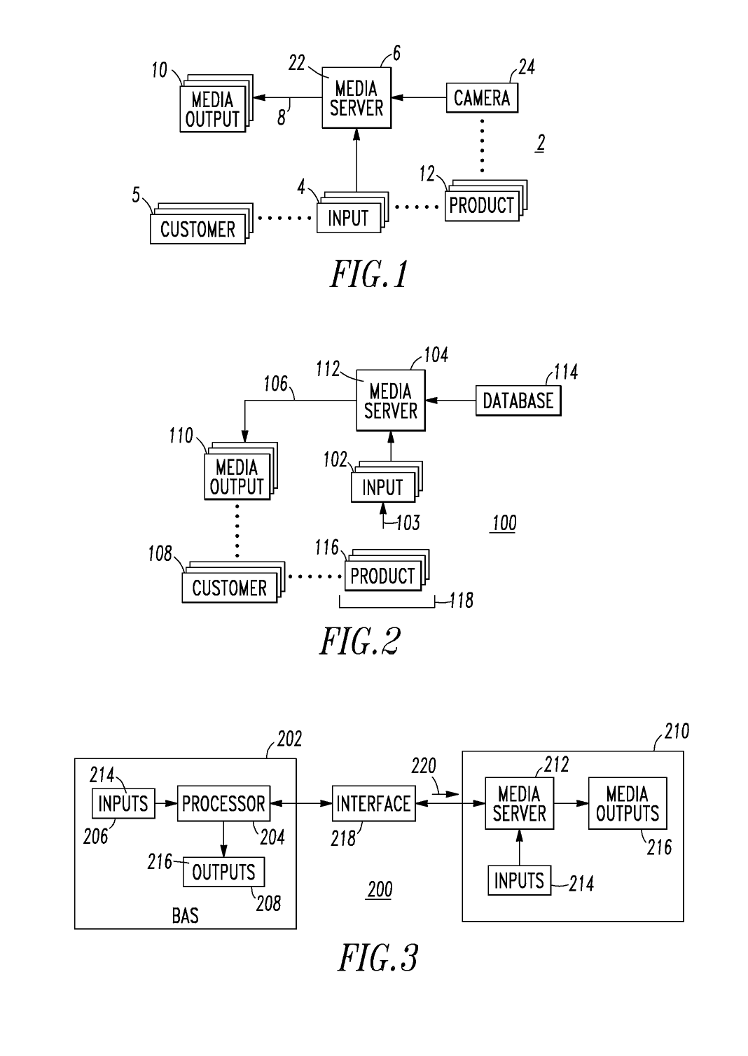

Referring to FIG. 1, a media delivery system, such as the example interactive media delivery system (IMDS) 2, includes a number of inputs 4 structured to input information pertaining to a number of customers 5, information pertaining to a number of demographics of the number of customers 5, or information pertaining to a number of products 12 possessed by the number of customers 5. A media server 6 is structured to input the number of inputs 4 and to determine corresponding marketing information 8 directly pertaining to at least one of the number of customers 5, the number of demographics or the number of products 12. A number of media outputs 10 (e.g., without limitation, a number of media displays) from the media server 6 are structured to output the corresponding marketing information 8 to a corresponding number of the number of customers 5.

### EXAMPLE 1

The IMDS 2 gathers information pertaining to a customer, such as 5, and the surrounding environment and, for example, displays through one of the media outputs 10, a unique and personal marketing message, such as 8, directed to the individual customer, such as 5, or, more generally, directed to a specific demographic of the number of customers 5.

The number of inputs 4 can be structured to input information pertaining to a number of products 12 possessed by the number of customers 5. The number of media outputs 10 can be structured to output a marketing message as the corresponding marketing information 8. For example and without limitation, the media server 6 is a centralized media server, which receives the inputs 4 from sensors (not expressly shown, but part of the inputs 4), but part of the inputs 4, evaluates a plurality of predetermined user input controls (not expressly shown, but part of the inputs 4), and controls the media outputs 10 (e.g., multimedia outputs) to provide a dynamic or interactive marketing environment. For example, an automated marketing feedback loop (not shown) of the media server 6 gathers as much information as possible from its environment, and processes that information to make decisions to control marketing elements within a building (not shown). In this manner, a number of the customers 5 can experience a new and unique message every time that they enter a store.

The inputs 4 can be, for example and without limitation, wired or wireless sensors, such as a clock, a push button, a touch screen monitor, a motion sensor, a proximity sensor, an occupancy sensor, video cameras, pressure pads, RFID tags on people, and/or RFID tags on or in the products 12 or on or in handheld electronic devices (e.g., cell phones; wireless personal media players (e.g., iPod® devices)). By directing a query to these inputs 4, or by processing a video image from the inputs 4, it is possible for the IMDS 2 to learn about the preferences of the customer 5 and deliver a tailored marketing message 8 to them.

The multimedia outputs 10 can be, for example and without limitation, wired or wireless devices, such as audio/video, light cubes, digital signage, facility lighting, decorative lighting, a scent generator, and/or HVAC devices.

Non-limiting examples of functions performed by the IMDS 2 include determining the products 12 in a shopping cart (e.g., using a camera; using an RFID tag) and outputting a corresponding marketing message 8, knowing music preferences (e.g., querying a Bluetooth™ enabled MP3 player) and outputting a corresponding marketing message 8, determining which product 12 was just selected (e.g., using a camera; using a proximity sensor; using a pressure pad) and outputting a corresponding marketing message 8, changing digital signage 10 to convey a personalized marketing message 8 responsive to the detection of a group of people 5 having an estimated age or height, or querying a smartcard (e.g., contactless, RFID-based loyalty card including an RFID tag) to determine which person 5 is in proximity to a media output 10, such as a media display, their personal profile and/or their buying preferences and outputting a corresponding marketing message 8.

A predetermined user input control can be, for example and without limitation, a set of “trigger events” or a sequence of one or more of the inputs 4. For example, the user generates a set of “scripts”, which defines a sequence of multimedia outputs 10 and grabs existing multimedia from a centralized media server, such as 6, provided that it does not already exist on a local server (not shown). A local server can be, for example, the local memory for whatever media outlet the content sits on. In other words, if the system does not stream video, the content needs to be physically copied to the local media outlet for playback. A user then associates each “script” with a “trigger event” such that whenever a trigger event occurs, it launches the appropriate script, which controls a number of the multimedia outputs 10. Preferably, this is defined through a suitably user-friendly user interface (not shown), and the control is automated by the media server 6.

For example, the media server 6 can employ a suitable software package (not shown) having both an editor 52 (FIG. 5) and a player 58 (FIG. 5) that can push the outputs 10 (e.g., still images; audio; high-definition video) based on the received inputs 4 (e.g., without limitation, a wireless channel; ZigBee™; a serial channel; TCP/IP; Bluetooth™). A suitable application (e.g., Objective-C) runs on a suitable processor (e.g., a Mac Mini computer) (not shown) of the media server 6. The server's content storage (not shown) can be a combination of one or more of locally distributed, on-demand multiplexed streaming, and a central server (i.e., a networked, centralized server (e.g., an interfaceable storage device, typically a desktop computer) that acts as the hub for distributed storage devices to manage content distribution or that acts as a stand-alone storage solution depending on the needs of the customer) depending on, for example, the layout, scale, and network needs.

### EXAMPLE 2

The IMDS 2 gathers information pertaining to a specific demographic associated with a number of customers 5 (e.g., about a specific customer; about a plurality of customers 5 in a specific area; about the surrounding environment (e.g., a product 12 selected by a customer 5)) and displays a unique and personal marketing message 8 to a specific demographic of the number of customers 5 (e.g., to the specific customer; to a group of customers). The IMDS 2 provides dynamic interaction with (e.g., unique and targeted media delivery to) the number of customers 5. The IMDS 2 can include a system of devices that interact with an entire building for a unique customer experience. For example, by knowing more about a person's purchasing preferences, a marketing message 8 can be tailored for them and, thereby, increase the affinity to the message and the probability of the person purchasing a corresponding product 12.

The inputs 4 can be a number of video cameras outputting a number of video images. The media server 6 can be structured to determine the height of the person 5. The demographics can include an age or a height of the person 5.

For example, in terms of specific demographics of the customers 5, video cameras (as opposed to cameras) are re-purposed using image processing techniques to determine the height of the person 5. Then, the determined height is related to age, for example, and a corresponding marketing message 8 directed to that age demographic is output by the media server 6.

### EXAMPLE 3

As another example, the output 10 is digital signage that can be changed to display a personal marketing message 8 based upon the determined age of a person 5 or from information in a smartcard or database using an ID of an RFID tag.

### EXAMPLE 4

The number of inputs 4 can include a number of RFID tags operatively associated with one of the number of customers 5. As one example, the inputs 4 can be structured to input from a smartcard to determine a specific person as the number of customers 5.

RFID tags operatively associated with a person 5 can take many forms. For example and without limitation, an RFID tag is embedded into a person's frequent shopper card or customer loyalty type card. Such a card need not include any memory. Instead, the media server 6 inputs an ID from the RFID tag and uses that ID to access a database (not shown) to collect corresponding information, such as age, gender, purchasing history and/or other demographic information.

Alternatively, an RFID tag could be embedded onto a shopping cart or something else that the person carries around, such as a frequent shopper card, a customer loyalty card, a shopping bag, and a product.

As one example, as shown in FIG. 6, an RFID tag 13 identifies a person's gender and, when detected by the media server 6, indicates that a particular person is present in a room. A motion sensor 14 also detects the person's specific position in a room. Two or more monitors 16,17 are coupled to a number of media servers 6,6A that hold a plurality of different video messages 8 that can be used depending on different scenario possibilities. The video content from one of the monitors 16 interacts with, for example, the customer 5, other output devices 18, as well as the other video monitor 17 in order to create a very non-linear experience. For example, in a non-linear experience, there are multiple points in the multimedia output where a particular path can branch off. This is contrasted with a linear experience where the sequence of outputs is predetermined and cannot change. More specifically, in a non-linear experience, there are multiple potential output paths or branches that can be taken depending on a series of a number of inputs at a number of different points in a timeline.

### EXAMPLE 5

The RFID tags can include an RFID tag 13 carried by a portable object 20 (e.g., without limitation, a smartcard; a portable handheld electronic device; a frequent shopper card; a customer loyalty card; a shopping cart; a shopping bag; a product) operatively associated with one of the customers 5. In this manner, server inquiries to handheld electronic devices, such as cell phones and iPOD® devices, including an RFID are done wirelessly through, for example, Wi-Fi, Bluetooth™, ZigBee™ or another suitable wireless communication interface.

### EXAMPLE 6

The number of inputs 4 can be structured to determine a number of specific types of the number of products 12. The inputs 4 can be structured to input information pertaining to the number of products 12 from a portable object, such as a portable handheld electronic device 20. The information pertaining to the number of products 12 can be a plurality of music preferences.

RFID tags 13 operatively associated with products 12 can take relatively many forms. As one example, an RFID tag is coupled to a compact disk (CD) or a DVD. Whenever the RFID tag 13 is detected by the media server 6, this acts as a “trigger event” which generates a “script” that defines a multimedia output 10 of a sound recording corresponding to the CD or a motion picture corresponding to the DVD.

As another example, an RFID tag 13 is coupled to a swimsuit or snow suit. Whenever the RFID tag 13 is detected in a changing room by the media server 6, this acts as a “trigger event” which generates a “script” that defines a multimedia output 10 of a lighting change that temporarily changes the “perceived” temperature, thereby making the person feel like they are in the tropics or the arctic.

### EXAMPLE 7

The media server 6 can include an image processor 22, as shown in FIG. 1. As an alternative to RFID tags 13 operatively associated with the products 12, user selected products can be determined by a camera 24 using suitable image processing techniques, such as for example and without limitation, image-differencing, object-tracking, pattern recognition, and barcode scanning.

### EXAMPLE 8

User selected products 12 can also be determined by a suitable sensor 25 (e.g., without limitation, a proximity sensor; a pressure pad) as shown in FIG. 6. For example, a proximity sensor contains two pieces, a sensor 26 and an emitter 27. The sensor 26 is placed on a shelf 28 for the product 12 and the emitter 27 is placed on or in the product 12. When the emitter 27 gets a specified distance away from the sensor 26, a signal 30 is produced to indicate that the product 12 has been removed from the shelf 28 (and, thus, can be assumed to be possessed by one of the customers 5 (FIG. 1)). Alternatively, a pressure pad (not shown) sits on the bottom of the shelf 28 and a number of products 12 sit on top of the pressure pad. As soon as a product 12 is removed (or is returned to the shelf 28), the weight on the pressure pad changes and the pressure pad produces a signal to indicate the change back to the media server 6.

### EXAMPLE 9

Media outputs 10 from the IMDS 2 of FIG. 1 can include changes to signage to display a personal message (e.g., dynamic digital signage). Digital signage can include, for example and without limitation, a video monitor and an LED marquee sign. The output to the digital signage is determined based on the various inputs 4 to the IMDS 2. For example, with an RFID tag 13 (FIG. 6), the IMDS 2 can uniquely output information that is unique to the individual (e.g., without limitation, displaying “Hey Johnny, you should check out this new sound system in the electronics department”). By using an RFID tag 13 on a customer loyalty card, the IMDS 2 knows the person's name, the last time they were in the store and whether they purchased similar products. The IMDS 2 can take the person's picture as they walk in the store (or even a live video feed) and superimpose the picture on a brand new boat to try to get them to buy the boat.

### EXAMPLE 10

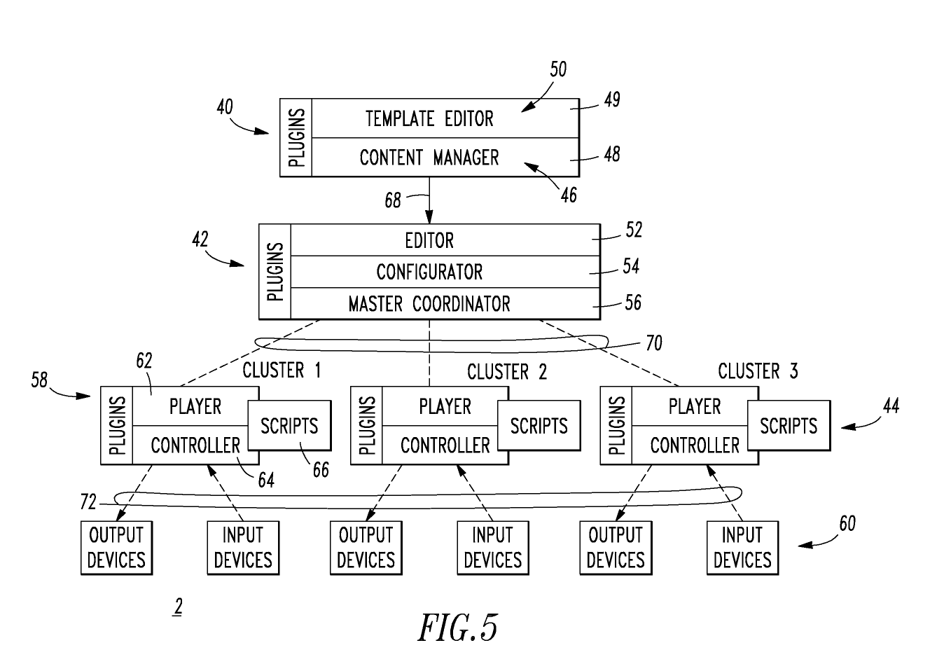

Referring to FIG. 4, there can be, for example, three primary levels of application support involved in the IMDS 2 (FIG. 1): a Management Level 40, a Storefront Level 42, and a Device Cluster Level 44, although the IMDS 2 is applicable to any number of levels.

The Management Level 40 represents centralized corporate management where content and messages are created, managed and distributed. The Storefront Level 42 represents each individual store within a corporation where the media outputs 10 (FIG. 1) (e.g., physical devices) reside. The Device Cluster Level 44 represents clusters or departments within the store where devices interact with one another and where content is actually delivered. A cluster, for example, might include the electronics department or the clothing department within a retail store. These three levels 40,42,44 exist as a hierarchy where typically there exists one Management Level 40, and beneath it there can be several storefronts, and then within each storefront, there can exist multiple device clusters. However, there is no requirement that the Management Level 40 even exists, for which case each storefront would act independently. There is also no requirement that there be multiple storefronts or even multiple device clusters. The IMDS 2 can be fully functional whether there are multiple storefronts and multiple clusters or a single storefront with a single cluster.

Also referring to FIG. 5, the Management Level 40 includes a content manager 46 where project templates 48 are created and the raw content is managed and distributed. This essentially represents the core backbone of the IMDS 2 from an upper management perspective. This level might or might not exist depending on the size of the user and the scale of the implementation. For a relatively larger user with a relatively large-scale implementation across a broad number of storefronts, the Management Level 40 exists to allow a user to manage marketing campaigns simultaneously across many fronts in order to present a unified marketing message relatively quickly and efficiently. At this level, the user has a choice of creating either a fully-completed project file, where each storefront will run the exact same content, or a project template file 49, where the individual storefronts can fill in the missing content relative to their varying needs. There are two primary software elements involved at this level: a project template editor 50, and the content manager 46. The editor 50 creates and modifies the project files 49 and/or the project template files 48. The content manager 46 quickly and efficiently distributes these files 48,49 and the content associated with them to the storefronts. Also, since this level includes the backbone of the operations, some level of network management is employed at both a software and hardware level, potentially including media and content servers.

The Storefront Level 42 includes where the user creates the final completed project files, where those files are loaded into the IMDS 2, and where the IMDS 2 is executed and managed on a local level. This is essentially the “brain” of the local portion of the IMDS 2, and it can be thought of as being similar to a facility server. Depending again on the size of the user and implementation, the Storefront Level 42 either receives the content directly from the Management Level 40, or it has the capability to create the content locally. This is supported by a project editor 52, which serves to either complete a project template file or create a completed project file from scratch. After all editing is completed at either the Management Level 40 or the Storefront Level 42, the final output will be a fully-completed project file. Contained within the project file will be a series of script files. Each script file will then contain within it a series of stream files. This file structure creates a hierarchy where the project file defines how the script files should be managed; the script files in turn define how the stream files should be managed; and the stream files define how the end devices should be managed. The next software application at this level is the system configurator 54, which translates the soft devices defined in the project files to hardware-specific addresses in the physical space and ensures that all devices and content are present and working. The system configurator 54 initializes the end devices at the next level and loads any new content to the next level of the IMDS 2. This is essentially like a commissioning tool that needs to be used every time a new project file is loaded or edited. After the IMDS 2 is configured, it is ready to enter into the execution stage. At the storefront level, a master coordinator 56 manages the execution of the project file and its subsequent hierarchy of files. It serves as the global manager for all the micro-managed device clusters at the next level.

The Device Cluster Level 44 is where the input and output devices physically reside and where the IMDS 2 actually interacts with the customers 5 (FIG. 1). This level consists of a cluster coordinator 58 and any number of end devices 60, which may include both wireless and wired inputs and outputs. Depending on the size of the store and implementation, the entire store can potentially be one big cluster, or the store can be subdivided into multiple clusters. Although there is a notion of global events, the content and devices within a cluster are thought to mostly interact with devices and content only within its own cluster. In other words, there is some local connection or theme (e.g., the notion of departments within a large retailer). However, the IMDS 2 can be setup in any way that the user wishes. There are two primary software elements needed to support this level: a player 62, and a network controller 64, both of which reside within the cluster coordinator 58. The player 62 is where the actual execution and management of the cluster script and streams occur on a local basis. Each cluster contains one script file 66, which defines how the inputs affect which stream(s) the cluster should be executing. The stream files describe a timeline-based execution of outputs. If there is video associated as one of the outputs, this is also handled within the player 62. If there are multiple video streams associated with the cluster, then there may exist multiple players 62; however, one is identified as the cluster coordinator and the rest are defined as reduced-functionality or “dummy” players, which can handle only output execution of video (and/or audio) and are defined solely as end devices. The network controller 64 serves as the communication interface between the player 62 and any I/O end devices 60, translates any commands to and from the player 62, and handles any network latency behind the scenes to ensure that commands are executed appropriately, in order, and on time. The network controller 64 also notifies the player 62 and subsequently the master coordinator 56 of any network issues or if communication is lost to any of the devices.

At each level, there are different hardware elements that are employed for both the internal backbone (communication and network management), as well as actual user interfaces (both for the end-user as well as the actual customer). At the management level 40, again depending upon the size of the user and the implementation, there is a network backbone 68 (e.g., without limitation, TCP/IP Ethernet). Many companies need the ability to update a store's marketing campaigns across their entire franchise all at once. In addition, when video files become part of the marketing campaign (which is very often the case) there presents a need for mass storage and the distribution of multimedia content, which can be met by specialized servers and dedicated networks. At both the management level 40 and the storefront level 42, there is also a need for highly intensive computing capabilities (typical for high-end video-editing). The storefront level 42 will also need some capabilities for multimedia servers, although not necessarily on as large of a scale. At the device cluster level 44, the need for servers is not as prevalent, such that a storage medium with suitable processing capabilities can be employed. In addition, there is a need for transmitting relatively large multimedia files from the storefront 42 all the way out to the individual players 62. In order to maintain wireless mobility, there is a need for a relatively high-end wireless communication network 70 (e.g., without limitation, IEEE 802.11n) for relatively high bandwidth transmissions (which, for example, ZigBee™ Alliance cannot handle). This type of network is relatively expensive at the device cluster level 44, hence, a relatively low-bandwidth low-power communication standard 72 (e.g., without limitation, ZigBee™ Alliance) is employed including, for example, attachment (whether embedded or externally through an adapter) of wireless radios to the end devices 60 within the clusters. In addition to the servers, CPUs and network devices needed for the backbone of the IMDS 2, the end devices and sensors are also employed.

The end devices 60 include, for example and without limitation, video monitors, lighting, HVAC, scent generation and sensors. Sensors include, for example and without limitation, input sensors and RFID tags. In addition, lighting control by a building automation system (BAS) can be employed to control the lights surrounding a media display, to change illumination level or color (e.g., LED color-changing lights) in order to affect the aesthetics or “mood”, and to sequence the lights (e.g., runway lights) in order to “draw” people away from other areas of the building to the media display. An HVAC system can be controlled to temporarily change the “perceived” temperature, making the person feel like they are in the arctic or tropics. A BAS occupancy sensor can be used to trigger events, or to potentially count the people present or viewing the IMDS media displays. Cameras can provide video input to the IMDS 2, which integrates images into the display output, or which is used to determine the number of people present or viewing the IMDS media displays. Cameras are used as an input back to the BAS and, thus, are dual-purposed. Pressure pads and occupancy sensors (as opposed to motion sensors or vibration sensors) are different ways of accomplishing the same result (e.g., determining when or where a person walks up to a display).

Energy savings is possible by turning off displays, lights and other demonstration equipment or machinery when it is determined that no people are present in the viewing space about the media displays. Hence, the BAS can be used to save energy and market products through a unified automation system. This saves money (by saving energy) and, also, makes money at the same time (by marketing and selling products). For example, conventional lighting control is usually schedule-based (e.g., turn on all the lights at 7 am and off at 6 pm), and there is lighting control based on sensor input like occupancy or ambient light. The IMDS 2 extends conventional lighting control by dual-purposing the BAS nodes in a building for marketing purposes. Similarly, conventional HVAC control nodes are dual-purposed for marketing purposes.

Since the BAS can be wireless, the IMDS 2 can piggy-back the existing wireless nodes to extend the range of the network (e.g., using multi-hop mesh networking).

Preferably, the IMDS 2 is completely automated, with the exception of commissioning and setting up the IMDS 2 to operate as desired.

FIG. 2 shows a media delivery system 100 including a number of inputs 102 structured to input information 103, a media server 104 structured to input the number of inputs 102 and to determine corresponding marketing information 106 directed to a number of customers 108, and a number of media outputs 110 from the media server 104. The system 100 can be similar to the IMDS 2 of FIG. 1. The number of media outputs 110 are structured to output the corresponding marketing information 106 to a corresponding number of the number of customers 108. The media server 104 is further structured to determine effectiveness 112 of the corresponding marketing information 106, as will be described. Briefly, the system 100 can perform data mining and determine the effectiveness on sales of specific marketing campaigns. Preferably, the media server 104 determines the effectiveness 112 in real time, as will be described.

### EXAMPLE 11

For example, the system 100 includes an automated marketing feedback loop, which judges the efficiency of the system 100 based on point-of-sales data from a database 114 (e.g., from a number of cash registers). For example, the inputs 102 include BAS occupancy sensors, motion sensors, strategically placed sensors or any suitable sensors (wired or wireless). These inputs 102 are dual-purposed to interact with the marketing environment and, also, to use as feedback to correlate with point-of-sales (e.g., using a motion sensor to provide a relative idea of the traffic flow in a given area of a store and comparing that with sales of a feature product 116 in that area). Each device or sensor can perform multiple tasks. For example, a single motion sensor can count the people that pass by a media output 110 and/or trigger a video output. The system 100 can collect information at end nodes, aggregate the same at routers, and then process this at a central server, which contains a TCP/IP connection to a number of point-of-sales databases. The information 103 input by the inputs 102 pertains, for example, to a number of the customers 108, a number of demographics associated with the number of customers 108, or a number of products 116 associated with the number of customers 108.

### EXAMPLE 12

The media server 104 determines the effectiveness 112 through a metric, for example, by counting the number of people 108 present and viewing a display 110, counting the number of products 116 removed from a shelf 118, and calculating the effectiveness metric (e.g., number of people 108 present and viewing the display 110 divided by the number of products 116 removed from the shelf 118) from those counts.

For example, the marketing information 106 is directed to a plurality of products 116 on the shelf 118. The media server 104 determines the effectiveness 112 from a metric selected from the group consisting of: (a) a count of persons 108 proximate the number of media outputs 110 divided by a count of outputs of the corresponding marketing information 106; (b) a count of sold or leased products 116 related to the corresponding marketing information 106 divided by a count of outputs of the corresponding marketing information 106; (c) a count of products 116 related to the corresponding marketing information 106 and being removed from the shelf 118 divided by a count of outputs of the corresponding marketing information 106; and (d) a count of sales or lease revenue for products 116 related to the corresponding marketing information 106 divided by a count of outputs of the corresponding marketing information 106.

For example, the system 100 determines the effectiveness 112 by determining the total amount of money sold for a specific product 116 in a particular time interval (e.g., one hour; one day) divided by the count of times that the advertisement 106 for that product 116 was played. If the product advertisement 106 was played with a relatively high frequency, but the sales for the product 116 were not relatively very high, then the store owner or department manager knows that this was not an effective advertisement. For example, in order to do this, the system 100 accesses a conventional sales database 114 for the store or department and collects other needed data from a BAS (not shown) and/or sensors 102.

### EXAMPLE 13

Different metrics can be employed for different customers 108. For example, these metrics can be flexible and customizable for processing at a central server (not shown). The system 100 collects the information and aggregates it back to a suitable logging system (not shown). The resulting logged data can be correlated with sales to determine the desired metrics based on user preferences. This can be performed by a suitable combination of client and server software, wireless embedded systems, and/or Web services to access remote data.

### EXAMPLE 14

Preferably, the system 100 performs data mining and determines (e.g., in real time) the effectiveness 112 of sales of specific marketing campaigns as defined by the marketing information 106.

The system 100 can collect and time-stamp inputs 102 and correlate in real time the effectiveness of a marketing message 106. Various sensors or other inputs 102 are used by the system 100 to record, in the background, all of the events that occur. For example, a motion sensor 102 that might be placed to trigger a video output 110, could, in addition, count every time a motion event occurred even though it might not even change the output of the video. By recording the time of day that this event occurs, the system 100 can give the store owner real-time information pertaining to how many people 108 actually walked in front of a particular display 110. If the media server 104 is inside a building, then the system 100 can record how many times a particular message 106 was played. Then, the system 100 correlates this data back to the actual point-of-sales database 114 to determine the effectiveness 112 of these messages 106.

### EXAMPLE 15

The system 100 can count the number of people 108 present and currently viewing a display 110. For example, with video cameras 102, there are known image processing techniques to specifically count the exact number of people 108 in an image. Other sensors, such as motion sensors 102, can provide rough estimates of the number of persons 108 about a media display 110. For example, the system 100 can determine that no one is in the area, that one person 108 is in the area, that a few people 108 are in the area, or that relatively many people 108 are in the area. In other words, if there are five occupancy sensors 102 in an electronics department, and four of those sensors 102 currently show activity, then the system 100 knows that there are at least four people 108 in that area. Since more than one person 108 might have set off the occupancy sensors 102, there could easily be more than four persons 108; hence, this provides a general estimate of the count of persons 108. The granularity of what the system 100 knows depends upon the granularity of the count of input sensors 102 in a given area.

### EXAMPLE 16

The system 100 can count the number of products 116 removed from the shelf 118 by using, for example, a proximity sensor or pressure pad as was discussed above in connection with FIG. 6.

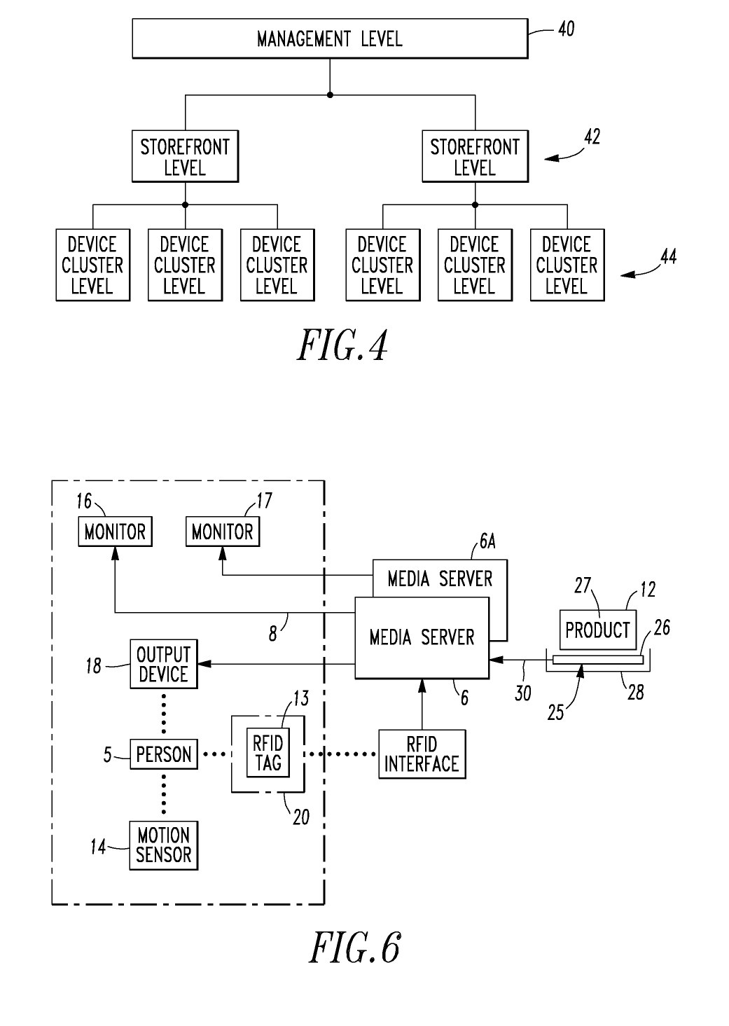

Referring to FIG. 3, a system 200 includes a building automation system (BAS) 202 having a processor 204, a plurality of inputs 206 to the processor, and a plurality of outputs 208 from the processor. The system 200 also includes a media delivery system 210 having a media server 212, a plurality of inputs 214 to the media server, and a plurality of media outputs 216 from the media server. A number of the media outputs 216 from the media server 212 are a number of the outputs 208 of the BAS 202. The system 200 further includes an interface 218 between the BAS 202 and the media delivery system 210. The interface 218 is structured to grant permission 220 from the BAS 202 to the media delivery system 210 to alter or control the number of the outputs 208 of the BAS 202.

For example, the outputs 208 of the BAS 202 are selected from the group consisting of a lighting node, an HVAC node, an automatic door node, and an energy management node.

As shown in the example of FIG. 3, the media server 212 is integrated with the BAS 202 by the example interface 218. The interface 218 employs, for example, a token-passing or handshaking mechanism with the BAS 202 to confirm that the media delivery system 210 has permission to alter or control an output 208 (e.g., a device or node) that is currently being used in the BAS 202 (e.g., a lighting node; an HVAC node; an automatic door node; an energy management node). In this manner, the BAS 202 can allow this interaction after which the device or node can resume normal operation within the BAS 202, or the BAS 202 can forbid the interaction and the device or node can maintain normal operation within the BAS 202. In either case, the media delivery system 210 does not interrupt critical services of the BAS 202.

### EXAMPLE 17

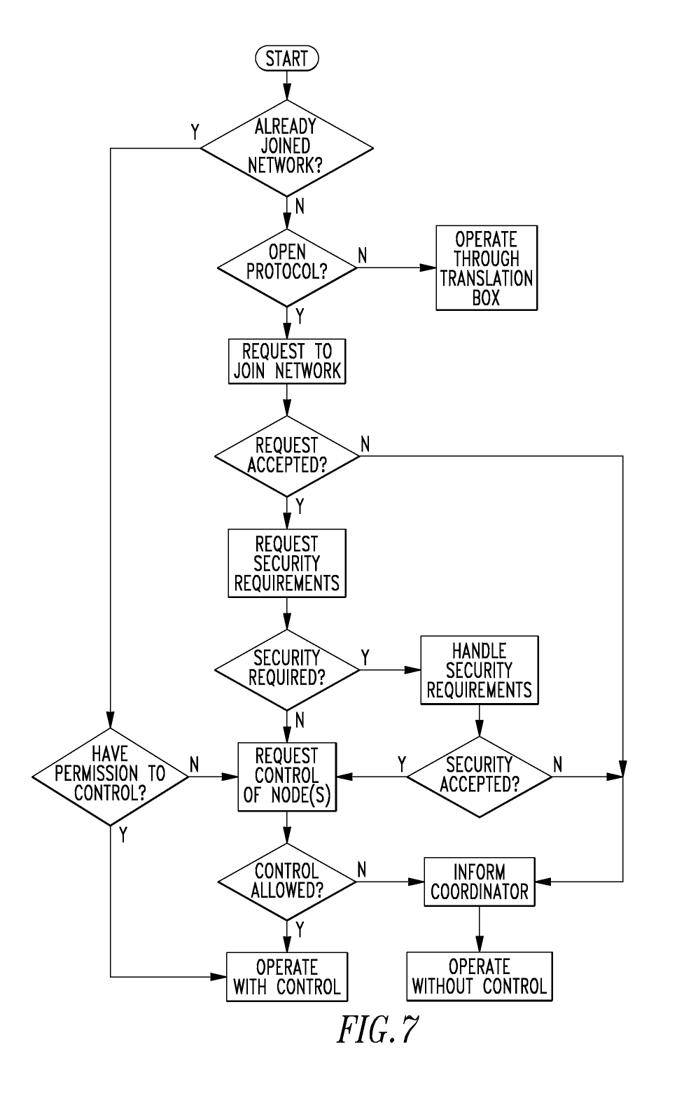

FIG. 7 is a flowchart that shows “hi-jacking” of BAS nodes by the system 210 without interrupting any critical element of the BAS 202. For example, the system 210 “asks permission” and performs a suitable handshaking task with the BAS 202 to allow it to control the outputs 208. This can involve, for example, a security token and/or a trust certificate. Ultimately, the BAS 202 can allow (i.e., operate with control) or forbid (i.e., operate without control) the requested interaction.

If the BAS 202 employs a proprietary protocol for communication, then a suitable “translation box” is employed that permits interaction. Preferably, for ease of access and implementation, the BAS 202 employs an open protocol, in which there are typically three different security paths. The first security path is that there is no security requirement, such that the system 210 can join and interact as needed. The other two security paths are typically either a “trust center” approach or an encrypted key. A “trust center” security path basically means that the network coordinator that is being interacted with will basically have a list of approved nodes. The system 210 would basically ask permission to join the network at which point the BAS 202 would need to add the system 210 as an approved node on the network.

The encrypted key security path basically means that the system 210 will need to be able to provide a key, which usually consists of a 128-bit hexadecimal string, in order to join the BAS network. This would either prompt the user to enter a key or, else, the key is included in a number of project files and/or the setup process.

In any case, the BAS nodes are preferably dual-purposed, both securely and non-intrusively.

### EXAMPLE 18

The BAS 202 is preferably structured to: (a) allow alteration or control of the number of the outputs 208 of the BAS 202 by the media delivery system 210 followed by normal operation of the number of the outputs 208 by the BAS 202; or (b) disallow alteration or control of the number of the outputs 208 of the BAS 202 by the media delivery system 210 and maintain normal operation of the number of the outputs 208 by the BAS 202. For example, the allow alteration or control of the number of the outputs 208 of the BAS 202 by the media delivery system 210 can provide a number of marketing functions, and the maintain normal operation of the number of the outputs 208 by the BAS 202 can provide a number of energy management functions.

### EXAMPLE 19

The media delivery system 210 can communicate with the BAS 202 to integrate additional I/O. The BAS 202 provides energy management functions (e.g., lighting control; HVAC control) in order to save energy and money on energy bills. Integrating the media delivery system 210 with the BAS 202 uses the BAS outputs 208 for marketing purposes, such that there is no conflict in who has control of the outputs 208. Also, the number of the inputs 214 to the media server 212 may be a number of the inputs 206 to the BAS processor 204.

The disclosed systems 2,100,200 can integrate interactive multimedia with a BAS, such as 202, in order to provide a more effective and engaging environment for the exchange of information with customers 5,108, and influence their perception or opinion of a product 12,116 or the message 8,106 being delivered to the customers 5,108. By communicating with the BAS 202, the interactive multimedia can integrate additional I/O 206,208 into the media delivery system 2,100,210. The systems 2,100,200 can take savings from an energy management system and exponentially improve those benefits by utilizing that system and repurposing it to help sell product 12,116.

Although wireless communications and various particular communication protocols are disclosed, a wide range of wired communications and/or communication protocols can be employed (e.g., without limitation, Ethernet; power line carrier (PLC)).

Although retail stores are disclosed, the disclosed systems 2,100,200 can be employed in a wide range of interactive multimedia applications (e.g., without limitation, entertainment venues (e.g., without limitation, movie theaters; theme parks); educational facilities (e.g., without limitation, museums); tradeshow environments).

Although counts of customers and/or the presence of customers are disclosed, the disclosed systems 2,100,200 can employ one or both of the action and the position of customers in providing interactive multimedia applications. In addition, the disclosed systems 2,100,200 can input or determine how long (e.g., number of seconds) a customer has been present, for example and without limitation, by the use of various sensors (e.g., without limitation, motion; occupancy; pressure pads). For example, if a customer walks up to a display for a product that has a motion sensor positioned about it, the customer will continue to trigger the motion sensor as long as he/she stays in the range of the motion sensor. This can be used to gauge the customer's interest in the product (i.e., the longer the customer spends in front of the display for the product, the more they are interested in the product) as opposed to someone just passing by the display. This can allow the system to present a more detailed advertisement instead of just something trying to catch a customer's attention.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A media delivery system comprising:
a number of inputs structured to input information pertaining to a number of customers, information pertaining to a number of demographics of said number of customers, or information pertaining to a number of products possessed by said number of customers;
a media server structured to input said number of inputs and to determine corresponding marketing information directly pertaining to at least one of said number of customers, said number of demographics or said number of products; and
a number of media outputs from said media server, said number of media outputs being structured to output the corresponding marketing information to a corresponding number of said number of customers.

2. The media delivery system of claim 1 wherein said number of inputs are structured to input information pertaining to said number of products; and wherein said number of media outputs are structured to output a marketing message as said corresponding marketing information.

3. The media delivery system of claim 2 wherein said number of inputs are further structured to determine a number of specific types of said number of products.

4. The media delivery system of claim 1 wherein said number of inputs are structured to input information pertaining to said number of products from a portable handheld electronic device.

5. The media delivery system of claim 4 wherein said information pertaining to said number of products is a plurality of music preferences.

6. The media delivery system of claim 1 wherein said number of inputs are structured to input from a smartcard to determine a specific person as said number of customers.

7. The media delivery system of claim 1 wherein said demographics include an age or a height of a number of persons.

8. The media delivery system of claim 7 wherein said number of inputs are a number of video cameras outputting a number of video images; and wherein said media server is further structured to determine the height of said number of persons.

9. The media delivery system of claim 8 wherein said media server comprises an image processor.

10. The media delivery system of claim 1 wherein said number of inputs include a number of RFID tags operatively associated with one of said number of customers.

11. The media delivery system of claim 10 wherein said number of RFID tags include an RFID tag which identifies one demographic of said number of demographics of said one of said number of customers.

12. The media delivery system of claim 10 wherein said number of RFID tags include an RFID tag carried by a portable object operatively associated with said one of said number of customers.

13. The media delivery system of claim 12 wherein said portable object is selected from the group consisting of a portable handheld electronic device, a frequent shopper card, a customer loyalty card, a shopping cart, a shopping bag, and a product.

14. A media delivery system comprising:
a number of inputs structured to input information;
a media server structured to input said number of inputs and to determine corresponding marketing information directed to a number of customers; and
a number of media outputs from said media server, said number of media outputs being structured to output the corresponding marketing information to a corresponding number of said number of customers,
wherein said media server is further structured to determine effectiveness of said corresponding marketing information.

15. The media delivery system of claim 14 wherein said media server is further structured to determine said effectiveness in real time.

16. The media delivery system of claim 14 wherein said corresponding marketing information is directed to a plurality of products on a shelf; and wherein said media server is further structured to determine said effectiveness from a metric selected from the group consisting of: (a) a count of persons proximate said number of media outputs divided by a count of outputs of the corresponding marketing information; (b) a count of sold or leased products related to said corresponding marketing information divided by a count of outputs of the corresponding marketing information; (c) a count of products related to said corresponding marketing information and being removed from the shelf divided by a count of outputs of the corresponding marketing information; and (d) a count of sales or lease revenue for products related to said corresponding marketing information divided by a count of outputs of the corresponding marketing information.

17. The media delivery system of claim 14 wherein said information input by said number of inputs pertains to a number of customers, a number of demographics associated with said number of customers, or a number of products associated with said number of customers.

18. A system comprising:
a building automation system comprising:
a processor,
a plurality of inputs to said processor, and
a plurality of outputs from said processor;
a media delivery system comprising:
a server,
a plurality of inputs to said server, and
a plurality of media outputs from said server, a number of said media outputs from said server being a number of said outputs of said building automation system; and
an interface between said building automation system and said media delivery system, said interface being structured to grant permission from said building automation system to said media delivery system to alter or control said number of said outputs of said building automation system.

19. The system of claim 18 wherein said number of said outputs of said building automation system are selected from the group consisting of a lighting node, an HVAC node, an automatic door node, and an energy management node.

20. The system of claim 18 wherein said interface is one of a token-passing mechanism and a handshaking mechanism between said building automation system and said media delivery system.

21. The system of claim 18 wherein said building automation system is structured to: (a) allow alteration or control of said number of said outputs of said building automation system by said media delivery system followed by normal operation of said number of said outputs by said building automation system; or (b) disallow alteration or control of said number of said outputs of said building automation system by said media delivery system and maintain normal operation of said number of said outputs by said building automation system.

22. The system of claim 21 wherein said allow alteration or control of said number of said outputs of said building automation system by said media delivery system provides a number of marketing functions; and wherein said maintain normal operation of said number of said outputs by said building automation system provides a number of energy management functions.

23. The system of claim 18 wherein a number of said inputs to said server are a number of said inputs to said processor.
